(19) United States
(12) Patent Application Publication
(10) Pub. No.: US 2025/0283408 A1
(43) Pub. Date: Sep. 11, 2025

(54) MODULAR PLATFORM SYSTEM FOR VERTICAL ORE STOPE MINING

(71) Applicant: NORDIC MINESTEEL TECHNOLOGIES INC., NORTH BAY (CA)

(72) Inventors: RONALD ELLIOTT, NORTH BAY (CA); BRYAN KELSO, NORTH BAY (CA); DARRYL TURRIE, NORTH BAY (CA)

(21) Appl. No.: 18/858,764

(22) PCT Filed: Apr. 26, 2023
(86) PCT No.: PCT/CA2023/050566

§ 371 Date: Oct. 22, 2024

Related U.S. Application Data
(60) Provisional application No. 63/336,495, filed on Apr. 29, 2022.

(51) Int. Cl. E21D 7/00; E21C 41/22

(52) U.S. Cl. CPC E21D 7/00; E21C 41/22

(57) ABSTRACT

A modular platform system for vertical ore stope mining, comprising: a top platform having an access opening formed therein for accessing a raise opening of a raise above a stope of a mine; an equipment deck adapted to receive equipment; and, at least one winch having at least one respective cable coupled thereto, the at least one winch mounted on the top platform, the at least one cable extendable through the access opening, the at least one cable having at least one respective cable end coupled to the equipment deck; wherein the at least one winch is operable to move the equipment deck and the equipment between a raised position proximate a top of the raise at the top platform and a lowered position proximate a bottom of the raise at a top of or within the stope.

This application claims priority from and the benefit of the filing date of U.S. Provisional Patent Application No. 63/336, 495, filed Apr. 29, 2022, and the entire content of such application is incorporated herein by reference.

### FIELD OF THE APPLICATION

This application relates to the field of platforms or lifts for mining, and more specifically, to a modular platform system for vertical ore stope mining, underground mining, stope mining, and the like.

### BACKGROUND

As the mining industry is constantly evolving, so are the safety standards required for miners and operators working in mining operations. For example, vertical ore stope mining is often performed using aged or obsolete equipment which places miners and operators at risk as they are in close proximity to blasting equipment, unstable geology, and often work deep below the surface in suboptimal conditions.

Underground ore mining generally involves the use of a vertical shaft or raise, which accesses horizontal drifts surrounding ore bodies, and a vertical stope in which rock fragmentation via drilling and blasting operations are conducted. Once fragmented, the newly blasted ore is collected and transported through an ore pass and/or back up the vertical shaft or raise to the drift and then on to the surface. Miners, operators, and equipment are typically transported to the drilling and blasting site via a platform, lift, or elevator system. One limitation of effective ore extraction in underground mines is the result of increasing mine depths, which results in increased geotechnical risks, longer travel times through the mine, greater ventilation requirements, and potentially dangerous working conditions for miners and operators.

In addition, there are several disadvantages of current underground ore mining methods. First, for the correct placement of a vertical stope and blasting equipment, miners and operators must work in close proximity to the equipment, deep underground, which may pose serious safety risks. Second, the efficiency and productivity of ore extraction in underground mines may be decreased due to human error and/or human limitations, more specifically, the time it takes to descend safely to the blasting site in the underground mine, set-up drill and blast equipment, and then to ascend again to a safe location during blasting operations. Third, the requirements for ventilation systems for underground mines are substantially increased and typically require automated systems to meet the needs of multiple sublevels, multiple openings in stopes, including sublevel openings, adequate contaminant removal, and increased system monitoring. Fourth, the infrastructure setup to ensure miner and operator safety with current methods is complex and time-consuming. Fifth, the drill and blast accuracy of current methods is problematic due to human error and/or limitations, and geotechnical challenges. Sixth, safely and quickly accessing a drilling and blasting site by miners and operators with the required equipment in the stope of an underground mine is time consuming and potentially dangerous using existing platform, lift, and elevator systems.

A need therefore exists for an improved platform system for mining operations. Accordingly, a solution that addresses, at least in part, the above and other shortcomings is desired.

### SUMMARY OF THE APPLICATION

According to one aspect of the application, there is provided a modular platform system for vertical ore stope mining, comprising: a top platform having an access opening formed therein for accessing a raise opening of a raise above a stope of a mine; an equipment deck adapted to receive equipment (e.g., mobile equipment and/or stationary equipment); and, at least one winch having at least one respective cable coupled thereto, the at least one winch mounted on the top platform, the at least one cable extendable through the access opening, the at least one cable having at least one respective cable end coupled to the equipment deck; wherein the at least one winch is operable to move the equipment deck and the equipment between a raised position proximate a top of the raise at the top platform and a lowered position proximate a bottom of the raise at a top of or within the stope.

### BRIEF DESCRIPTION OF THE DRAWINGS

Features and advantages of the embodiments of the present application will become apparent from the following detailed description, taken in combination with the appended drawings, in which:

FIG. 1 is a front perspective view illustrating a modular platform system positioned over a raise in an underground mine in accordance with an embodiment of the application;

FIG. 2 is a front perspective detail view illustrating the modular platform system of FIG. 1 in accordance with an embodiment of the application;

FIG. 3 is a front perspective view illustrating the top platform of the modular platform system of FIG. 1 in accordance with an embodiment of the application;

FIG. 4 is a top view thereof;

FIG. 5 is a front view thereof, the rear view being substantially a mirror image thereof;

FIG. 6 is a left side view thereof, the right side view being substantially a mirror image thereof;

FIG. 7 is a front perspective view illustrating the equipment deck of the modular platform system of FIG. 1 in accordance with an embodiment of the application;

FIG. 8 is a top view thereof;

FIG. 9 is a front view thereof, the rear, left side, and right side views being substantially the same;

FIG. 10 is a front perspective view illustrating the modular platform system of FIG. 1 with the equipment deck thereof shown in a raised position in accordance with an embodiment of the application;

FIG. 11 is a front perspective view illustrating the modular platform system of FIG. 1 with the equipment deck thereof shown in a lowered position in accordance with an embodiment of the application;

FIG. 12 is a front perspective view illustrating an equipment deck for the modular platform system of FIG. 1 having a removable cassette deck and with the removable cassette deck thereof shown in an inserted position in accordance with an embodiment of the application;

FIG. 13 is a bottom perspective view thereof;

FIG. 14 is a front perspective view illustrating the equipment deck of FIG. 12 with the removable cassette deck thereof shown in a removed position in accordance with an embodiment of the application;

FIG. 15 is a bottom perspective view thereof;

FIG. 16 is a front view thereof;

FIG. 17 is a rear view thereof;

FIG. 18 is a top view thereof;

FIG. 19 is a bottom view thereof;

FIG. 20 is a right side view thereof, the left side view being substantially a mirror image thereof;

FIG. 21 is a front perspective view illustrating the top deck of the equipment deck of FIG. 12 with the removable cassette deck thereof removed and with the top deck shown in an unfolded position in accordance with an embodiment of the application;

FIG. 22 is a front perspective view illustrating the top deck of the equipment deck of FIG. 21 with the removable cassette deck thereof removed and with the top deck shown in a folded position in accordance with an embodiment of the application;

FIG. 23 is a right side view thereof, the left side view being substantially a mirror image thereof;

FIG. 24 is a front perspective view illustrating the equipment deck of FIG. 12 with the removable cassette deck thereof shown in a removed position and with equipment mounted on the removable cassette deck in accordance with an embodiment of the application; and,

FIG. 25 is a front perspective view illustrating the equipment deck of FIG. 12 with the removable cassette deck thereof shown in an inserted position and with equipment mounted on the removable cassette deck in accordance with an embodiment of the application.

It will be noted that throughout the appended drawings, like features are identified by like reference numerals.

### DETAILED DESCRIPTION OF THE EMBODIMENTS

In the following description, details are set forth to provide an understanding of the application. In some instances, certain structures, techniques and methods have not been described or shown in detail in order not to obscure the application.

The present application provides an elevator-like mobile, modular, automated vertical ore stoping system (“VOSS”) (referred to in the following as a modular platform system 100). As further described below, the modular platform system 100 includes the following: a mobile, modular frame unit (or top platform 200) having forklift pockets and easy access lifting lugs; a modular base unit (or equipment deck 500, 1500) having remote capability, software integration, and drive on/drive off capability for drill rigs and explosives (e.g., equipment 8000); modular power units with plug and play cabling; mobile electrical components (e.g., IP 67 rated); LTE (i.e., Long-Term Evolution) wireless or cellular communications to the equipment deck 500, 1500; an optional raisebore concrete pad with rails; optional installation of a cap/collar/center line; optional manhole access on the equipment deck 500, 1500 for 3^{rd} party stop monitoring; and, an optional telescoping equipment deck 500, 1500 to provide double deck drilling capability. The modular platform system 100 may have a payload of 20,000 kg and a lift speed of 5-10 m/s according to one embodiment.

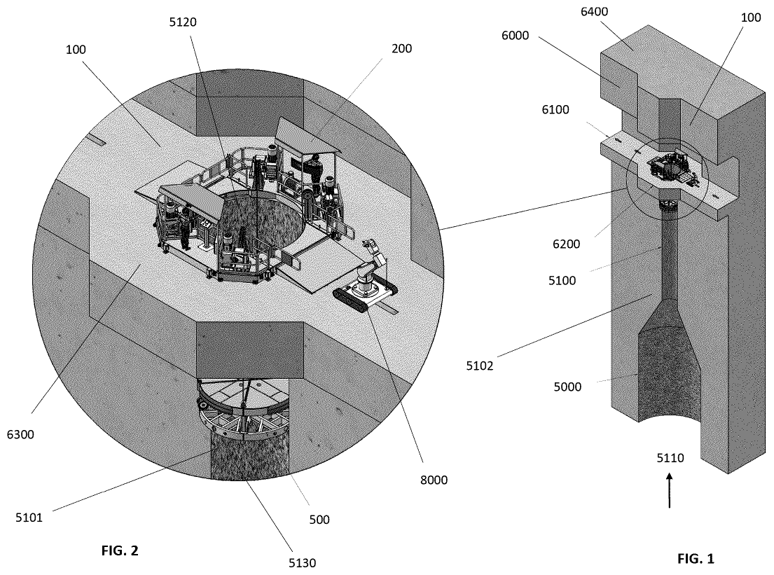

FIG. 1 is a front perspective view illustrating a modular platform system 100 positioned over a raise (e.g., a vertical raise) 5100 in an underground mine 6000 in accordance with an embodiment of the application. And, FIG. 2 is a front perspective detail view illustrating the modular platform system 100 of FIG. 1 in accordance with an embodiment of the application.

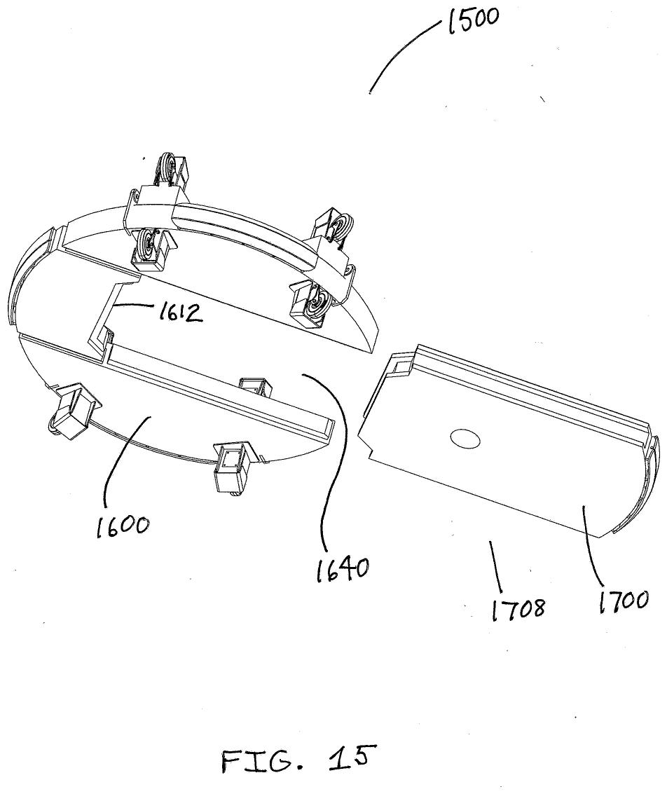

According to one embodiment of the application, there is provided a modular platform system (or system) 100 for mining operations (e.g., underground mining, stope mining, etc.). The modular platform system 100 includes: a top platform 200; an equipment deck 500 (or 1500 as described further below and as shown in FIG. 12); one or more cables 400 (e.g., 410, 420, 430, 440) coupling the top platform 200 to the equipment deck 500, 1500; and, a control system 300 for controlling and monitoring the modular platform system 100 and equipment 8000. The equipment 8000 may include mobile equipment 8000 (e.g., with wheels, with a tracked undercarriage, etc.) and/or stationary equipment 8000 (e.g., without wheels, without a tracked undercarriage, etc.). As further described below, the modular platform system 100 is modular and mobile, that is, the components 200, 300, 400, 500, 1500 of the modular platform system 100 may be easily relocated to different locations (e.g., above different raises 5100) in a mine (e.g., an underground mine 6000). The modular platform system 100 has a longitudinal axis 110, a lateral axis 120, and a vertical axis 130 that may be aligned with a vertical axis 5110 of a raise 5100 above a stope 5000 of the mine 6000. The top platform 200, equipment deck 500 (or 1500), and cables 400 are typically made from metal such as steel.

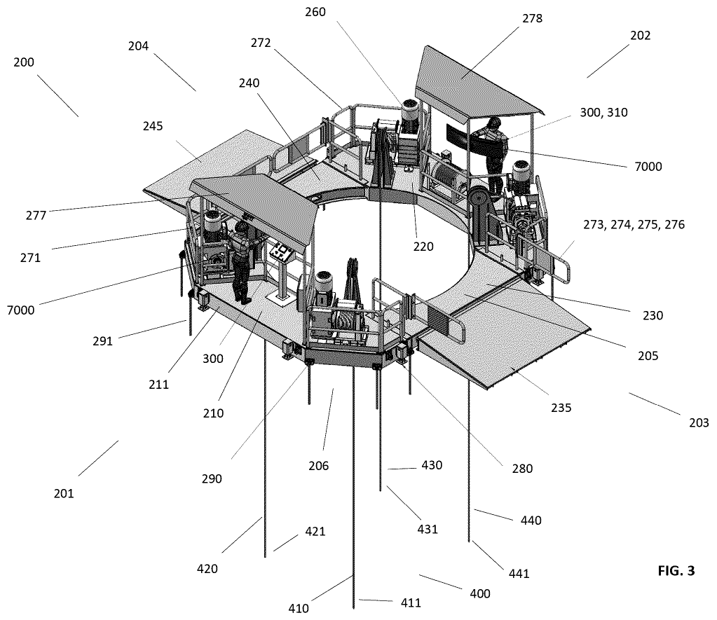

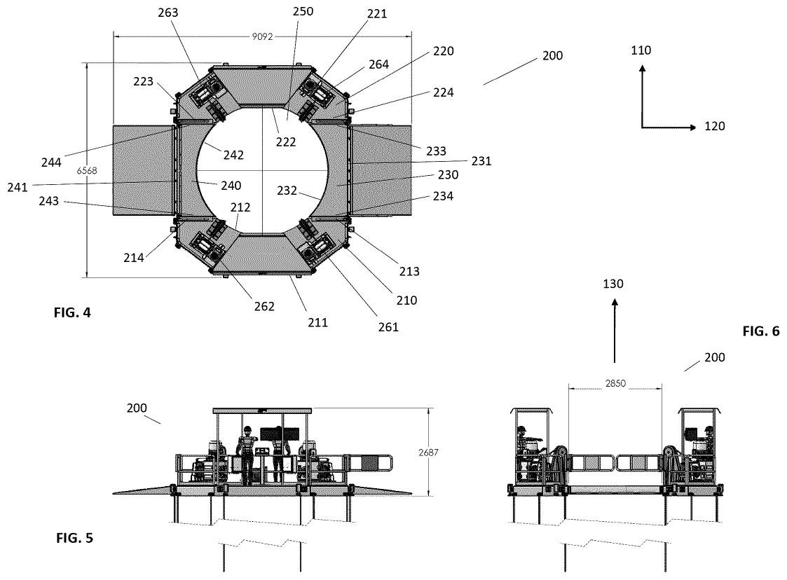

FIG. 3 is a front perspective view illustrating the top platform 200 of the modular platform system 100 of FIG. 1 in accordance with an embodiment of the application. FIG. 4 is a top view thereof. FIG. 5 is a front view thereof, the rear view being substantially a mirror image thereof. And, FIG. 6 is a left side view thereof, the right side view being substantially a mirror image thereof.

According to one embodiment, the top platform 200 has a front end 201, a rear end 202, a right side 203, a left side 204, an upper or top surface 205, and a lower or bottom surface 206. The top platform 200 includes a front platform or deck 210 for use by an operator 7000, a rear platform or deck 220 (also for optional use by the operator 7000), a right or first side platform or deck 230, and a left or second side platform or deck 240. The front deck 210 has an outer side wall (or side) 211, an inner side wall (or side) 212, a first or right side wall or end wall (or end) 213, and a second or left side wall or end wall (or end) 214. Similarly, the rear deck 220 has an outer side wall (or side) 221, an inner side wall (or side) 222, a first or right side wall or end wall (or end) 223, and a second or left side wall or end wall (or end) 224. The right side deck 230 has an outer side wall (or side) 231, an inner side wall (or side) 232, a first or right side wall or end wall (or end) 233, and a second or left side wall or end wall (or end) 234. Similarly, the left side deck 240 has an outer side wall (or side) 241, an inner side wall (or side) 242, a first or right side wall or end wall (or end) 243, and a second or left side wall or end wall (or end) 244.

The right end 213 of the front deck 210 is removably attached (e.g., coupled, bolted, fastened, pinned, etc.) to the left side 234 of the right side deck 230 and the right side 233 of the right side deck 230 is removably attached to the left end 224 of the rear deck 220. Similarly, the left end 214 of the front deck 210 is removably attached to the right side 243 of the left side deck 240 and the left side 244 of the left side deck 240 is removably attached to the right end 223 of the rear deck 220. As such, when the front, rear, right side, and left side decks 210, 220, 230, 240 are attached, a raise access opening (or central opening or access opening or opening) 250 is formed in the top platform 200 (i.e., defined by the respective inner sides 212, 222, 232, 242 of the front, rear, right side, and left side decks 210, 220, 230, 240).

According to one embodiment, the inner sides 212, 222, 232, 242 of the front, rear, right side, and left side decks 210, 220, 230, 240 (and/or the respective upper surfaces 205 thereof adjacent to the inner sides 212, 222, 232, 242) are curved or arced outwardly and hence the access opening 250 formed in the top platform 200 is circular (or approximately circular) in shape. Of course, the access opening 250 may be of any shape (e.g., square, oval, rectangular, etc.).

Referring again to FIGS. 1 and 2, the top platform 200 is sized to fit over and cover the opening (or raise opening) 5120 at the top 5101 of a raise (or raisebore or bore) 5100 formed in the floor 6300 of a drift 6100 or chamber 6200 above a stope 5000 in an underground mine 6000. Similarly, the access opening 250 formed in the top platform 200 is sized to match (or approximately match) the diameter 5103 of the raise 5100 (e.g., 4000 mm).

The top platform 200 is also sized to be moved along a drift 6100 in an underground mine 6000 and assembled in a chamber 6200 over the raise 5100 above a stope 5000. When assembled, as shown in FIGS. 4 to 6, the top platform 200 may measure approximately 9092 mm wide by 6568 mm deep by 2687 mm high according to one embodiment.

According to one embodiment, first and second synchronized winches 261, 262 may be spacedly mounted on the upper surface 205 of the front deck 210 proximate the right and left ends 213, 214 thereof, respectively. Similarly, third and fourth synchronized winches 263, 264 may be spacedly mounted on the upper surface 205 of the rear deck 220 proximate the right and left ends 223, 224 thereof, respectively. The first, second, third, and fourth synchronized winches 261, 262, 263, 264 are equipped with first, second, third, and fourth cables 410, 420, 430, 440, respectively, as further described below.

The synchronized winches 260 (e.g., 261, 262, 263, 264) may be electrically or hydraulically powered and may have the following ratings according to one embodiment: a capacity of 4,490 Kg; a rope (cable) diameter of 18 m; a speed of 14 m/min; and, a drum storage of 200 m.

According to one embodiment, first and second ramps 235, 245 are removably attached to respective outer sides 231, 241 of the right and left side decks 230, 240. The first and second ramps 235, 245 provide improved access to the equipment deck 500 (or 1500) for mobile (or stationary) equipment 8000 from the drift 6100. The ramps 235, 245 may have a width of 2850 mm according to one embodiment.

According to one embodiment, the respective upper surfaces 205 of the front and rear decks 210, 220 have mounted thereon respective safety railings 271, 272, safety gates 273, 274, 275, 276, and canopies 277, 278 for the protection of operators 7000 working on or near the modular platform system 100.

According to one embodiment, the outer sides 211, 221 of the front and rear decks 210, 220 may have one or more (e. g., four (4)) leveling jacks 280 spacedly mounted thereto for leveling the system 100 with respect to the floor 6300 of the drift 6100 or chamber 6200 of the mine 6000 where the modular platform system 100 is deployed. In addition, the outer sides 211, 221 of the front and rear decks 210, 220 may have one or more (e.g., six (6)) anchoring pads 290 and anchors 291 spacedly mounted thereto for anchoring the modular platform system 100 to the floor of the floor 6300 of the drift 6100 or chamber 6200.

According to one embodiment, the control system 300 is mounted on the upper surface 205 of the front deck 210 and is used for local control and monitoring of the modular platform system 100 and its components (e.g., synchronized winches 260, power supplies 580, etc.). According to another embodiment, the control system 300 may be remotely located and may be communicatively coupled to the modular platform system 100 and its components over a wired or wireless communications network (e.g., cellular, WIFI, LAN, WLAN, etc.) 351 for remote control and monitoring of the modular platform system 100 and its components.

The control system 300, whether located locally or remotely, may be used for the local or remote control of the equipment 8000 that is transported by the modular platform system 100 to and from the stope 5000 via the raise 5100. The control system 300 may make use of CCTV cameras or the like mounted on the equipment platform 500 (or 1500) when controlling equipment 8000. The control system 300 may include one or more local or remote user interfaces, input devices, and output devices (e.g., keyboards, control panels, displays, touchscreens, graphical user interfaces, joy sticks, mice, printers, buttons, etc.) 310 for receiving commands from an operator 7000 and for presenting information (e.g., status indications, measured values, alarms, etc.) to the operator 7000.

The control system 300 may include software modules stored in memory for local control, maintenance, installation, commissioning, and for integration into surface control for remote operation. In addition, the control system 300 may include software modules for locating a drill site within a raise 5100 or stope 5000, locking drilling equipment 8000 in place, powering the drill bit of the drilling equipment 8000, and communicating the progress of drilling operations to the operator 7000 via the communications network 351 and user interface 310.

Advantageously, the control system 300 allows for controlling the modular platform system 100, its components (e. g., 260, 580, etc.), and mobile (or stationary) equipment 8000 by and operator 7000 from a location distant from the raise 5100 and stope 5000 and even from a location distant from the drift 6100, chamber 6200, and mine 6000 itself such as at the surface 6400. As such, the operator 7000 need not venture near the raise opening 5110 during mining operations.

According to one embodiment, at least one the first, second, third, and fourth cables 410, 420, 430, 440 (collectively 400) may include electrical power and communications cables for providing the equipment deck 500 (or 1500) with electrical power and communications capability and thereby allowing the equipment 8000 to be operated remotely by the control system 300 when the equipment deck 500 (or 1500) is in the lowered position 502 as described further below. According to one embodiment, the equipment deck 500 (or 1500) may optionally include a stand-alone power supply 580 such as one or more batteries. According to one embodiment, the wired or wireless communications network 351 of the control system 300 may be extended to the equipment deck 500 (or 1500) whether in its raised 501 or lowered 502 positions.

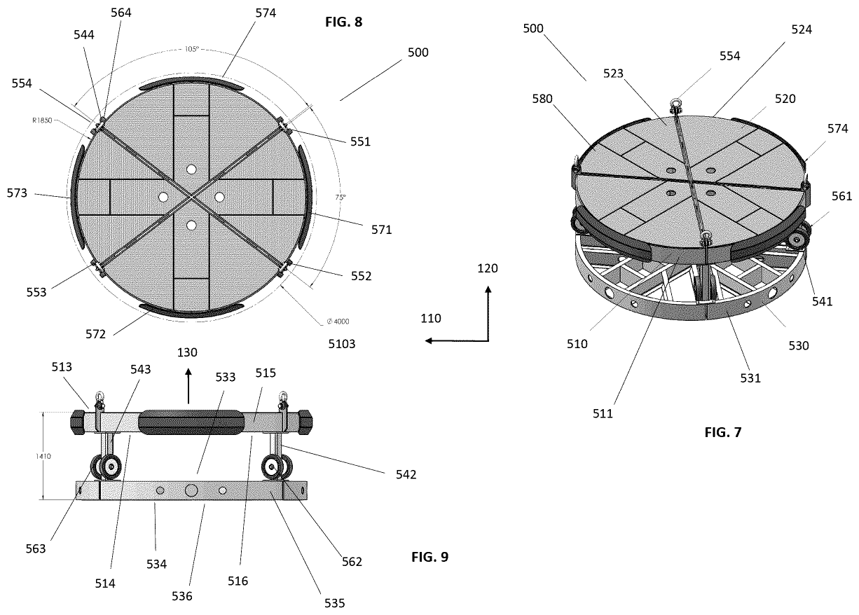

FIG. 7 is a front perspective view illustrating the equipment deck 500 of the modular platform system 100 of FIG. 1 in accordance with an embodiment of the application. FIG. 8 is a top view thereof. And, FIG. 9 is a front view thereof, the rear, left side, and right side views being substantially the same.

The equipment deck 500 includes: a top deck 510 having an upper surface 513, a lower surface 514, and at least one side wall (or side) 511 having an outer surface 515 and an inner surface 516; a work platform 520 having an upper surface 523 and a lower surface 524, the lower surface 524 attached (e.g., one or more of attached, connected, joined, bolted, welded, screwed, pinned, hinged, etc.) to the upper surface 513 of the top deck 510; a bottom deck 530 having an upper surface 533, a lower surface 534, and at least one side wall (or side) 531 having an outer surface 335 and an inner surface 536; first, second, third, and fourth elongate struts 541, 542, 543, 544 spacedly attached between the lower surface 514 of the top deck 510 and the upper surface 533 of the bottom deck 530 to attach and space the top deck 510 to and from the bottom deck 530; first, second, third, and fourth lift/anchor points 551, 552, 553, 554 spacedly mounted to the outer surface 515 of the side wall 511 of the top deck 510 proximate the first, second, third, and fourth elongate struts 541, 542, 543, 544, respectively; and, first, second, third, and fourth guide wheels (or guide wheel pairs) 561, 562, 563, 564 mounted to the first, second, third, and fourth struts 541, 542, 543, 544, respectively. The guide wheels 561, 562, 563, 564 may be rubber guide wheels (or have rubber tires).

The equipment deck 500 (or 1500) is sized, shaped, and configured to mate with the top platform 200 via the access opening 250 formed in the top platform 200. Accordingly, according to one embodiment, the top deck 510 and the bottom deck 520 may be circular in shape as shown in FIGS. 7 to 9. As shown in FIG. 8, according to one embodiment, the equipment deck 500 (or 1500) may measure approximately 1850 mm in radius to fit a raise diameter 5103 of approximately 4000 mm.

The outer surface 515 of the side wall (or side) 511 of the top deck 510 may have first, second, third, and fourth stabilizers 571, 572, 573, 574 spacedly mounted thereon for improving stability of the equipment deck 500 when docked in the top platform 200 when in the raised position 501. The stabilizers 571, 572, 573, 574 may provide a closer fit between the outer surface 515 of the top deck 510 and the inner side walls 212, 222, 232, 242 of the front, rear, right, and left platforms 210, 220, 230, 240 of the top platform 200. As shown in FIG. 8, the first, second, third, and fourth stabilizers 571, 572, 573, 574 may be spaced 90 degrees (or approximately 90 degrees) apart around the circumference (i.e., side wall 511) of the top deck 510 (i.e., between the first, second, third, and fourth lift/anchor points 551, 552, 553, 554.)

As shown in FIGS. 7 to 9, the first, second, third, and fourth elongate struts 541, 542, 543, 544 may be sequentially spaced 75 degrees (or approximately 75 degrees), 105 degrees (or approximately 105 degrees), 75 degrees (or approximately 75 degrees), and 105 degrees (or approximately 105 degrees) apart, respectively, around the circumference (i.e., side walls 511, 531) of the top and bottom decks 510, 530.

Also as shown in FIGS. 7 to 9, the first, second, third, and fourth lift/anchor points 551, 552, 553, 554 may be sequentially spaced 75 degrees (or approximately 75 degrees), 105 degrees (or approximately 105 degrees), 75 degrees (or approximately 75 degrees), and 105 degrees (or approximately 105 degrees) apart, respectively, around the circumference (i.e., side wall 511) of the top deck 510 and may be vertically aligned with the first, second, third, and fourth elongate struts 541, 542, 543, 544, respectively.

The first, second, third, and fourth guide wheels (or guide wheel pairs) 561, 562, 563, 564 may be pin or axle mounted to respective elongate struts 541, 542, 543, 544 between the top and bottom decks 510, 520 and are adapted and oriented to engage the side wall 5130 of the raise 5100 when the equipment deck 500 is moved between the raised and lowered positions 501, 502 as further described below.

Referring again to FIG. 4, the first, second, third, and fourth synchronized winches 261, 262, 263, 264 may be sequentially spaced 75 degrees (or approximately 75 degrees), 105 degrees (or approximately 105 degrees), 75 degrees (or approximately 75 degrees), and 105 degrees (or approximately 105 degrees) apart, respectively, around the circumference (i.e., inner walls 212, 222, 223, 242) of the access opening 250 in the top platform 200 and may be vertically aligned with the first, second, third, and fourth lift/anchor points 551, 552, 553, 554 of the equipment deck 500 (or 1500), respectively.

Advantageously, the 105 degree spacing between second and third synchronized winches 262, 263 and the first and fourth synchronized winches 261, 264 allows for improved and enlarged access to the equipment deck 500 (or 1500) (i.e., when in the raised position 501) for equipment 8000 via the ramps 235, 245.

Referring again to FIGS. 1 to 3, respective lower ends 411, 421, 431, 441 of the first, second, third, and fourth cables 410, 420, 430, 440 of the first, second, third, and fourth synchronized winches 261, 262, 263, 264 are coupled (e.g., attached by hook, spice, knot, etc.) to the first, second, third, and fourth lift/anchor points 551, 552, 553, 554 of the equipment deck 500 (or 1500), respectively. The synchronized winches 261, 262, 263, 264 raise 501 the equipment deck 500 (or 1500) by pulling in (winding up) the respective lower ends 411, 421, 431, 441 of the first, second, third, and fourth cables 410, 420, 430, 440 and lower 502 the equipment deck 500 (or 1500) by letting out (winding out) the respective lower ends 411, 421, 431, 441 of the first, second, third, and fourth cables 410, 420, 430, 440.

According to one embodiment, the equipment deck 500 (or 1500) may have two top decks 510 (or 1600) (i.e., the equipment deck 500 (or 1500) may be a double deck) or the equipment deck 500 (or 1500) may be a telescoping deck to facilitate two level drilling and blasting.

According to one embodiment, the top platform 200 and/or the equipment deck 500 (or 1500) may be equipped with forklift pockets and easy lifting lugs for improved mobility. According to one embodiment, the top platform 200 and/or the equipment deck 500 (or 1500) may make use of modular components such as power units or power supplies 580 with plug and play cabling. Electrical components may be IP 67 rated. And, services for components (e.g., 260) and equipment 8000, including hydraulics, pneumatics, and electrical, may be housed in separate panels or enclosures.

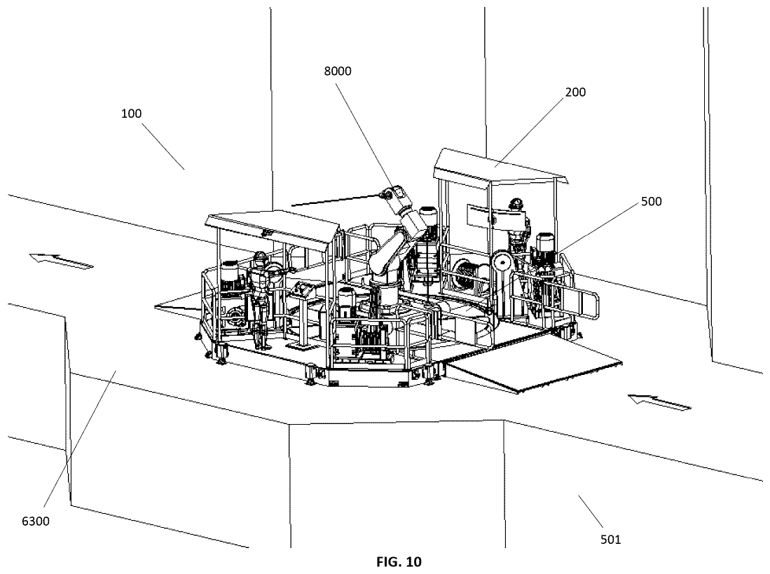

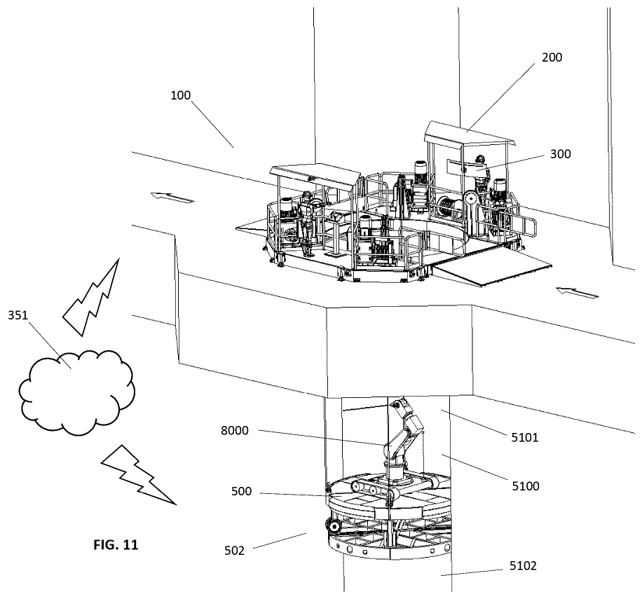

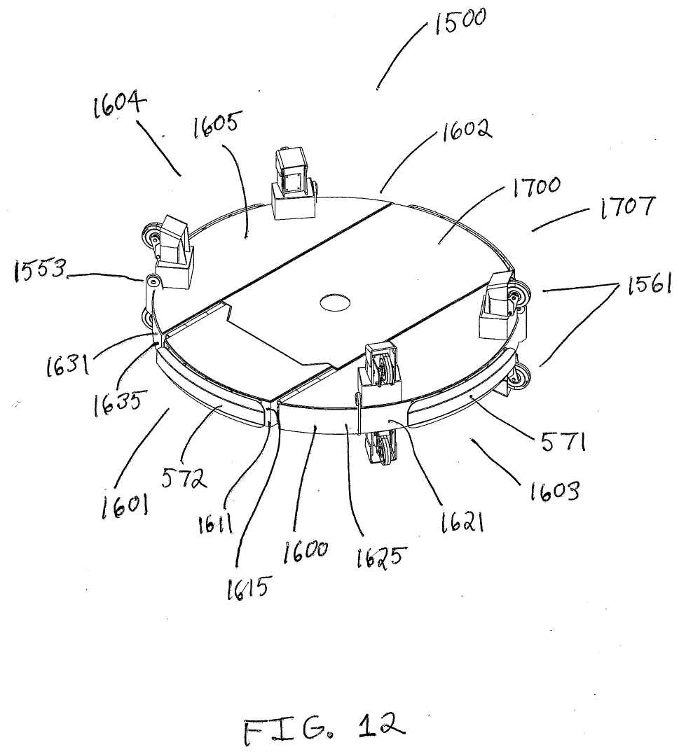

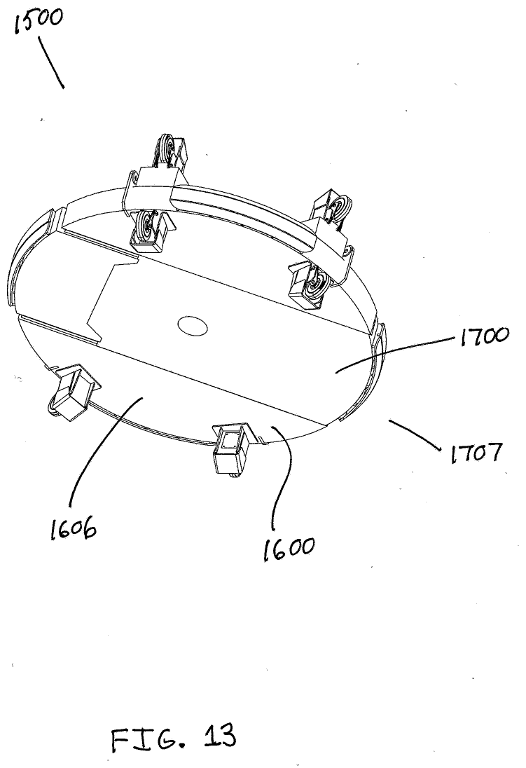

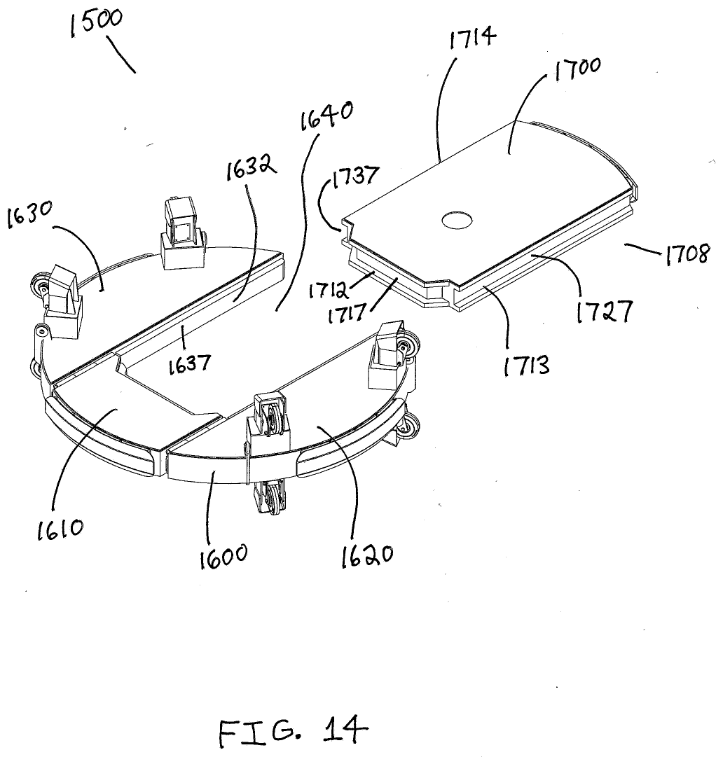

FIG. 10 is a front perspective view illustrating the modular platform system 100 of FIG. 1 with the equipment deck 500 (or 1500) thereof shown in a raised position 501 in accordance with an embodiment of the application. And, FIG. 11 is a front perspective view illustrating the modular platform system 100 of FIG. 1 with the equipment deck 500 (or 1500) thereof shown in a lowered position 502 in accordance with an embodiment of the application.

Referring to FIGS. 10 and 11, the synchronized winches 261, 262, 263, 264 (collectively 260) are operable to move the equipment deck 500 (or 1500) between a raised position 501 where the upper surface 523 of the work platform 520 of the equipment deck 500 is level (or approximately level) with the upper surface 205 of the top platform 200 proximate the opening 5120 of the raise 5100 (i.e., at the top 5101 of the raise 5100) in the floor 6300 of the drift 6100 or chamber 6200 of the mine 6000 and a lowered position 502 where the upper surface 523 of the work platform 520 of the equipment deck 500 is positioned proximate the bottom 5102 of the raise 5100 above the top of or within the stope 5000.

Advantageously, when in the raised position 501, the equipment deck 500 (or 1500) functions to close the access opening 250 for the safety of operators 7000.

In operation, the top platform 200 of the modular platform system 100 is assembled over a raise opening 5120 of a raise 5100 in a drift 6100 or chamber 6200 of an underground mine 6000. The lower ends 411, 421, 431, 441 of the first, second, third, and fourth cables 410, 420, 430, 440 of the first, second, third, and fourth synchronized winches 261, 262, 263, 264 are coupled to the first, second, third, and fourth lift/anchor points 551, 552, 553, 554 of the equipment deck 500 and the equipment deck 500 is docked in the raised position 501 in the access opening 250 of the top platform 200 at the top 5101 of the raise 5100. First equipment, for example, a mobile drill (or mobile drilling equipment) 8000 is moved via local or remote control by the control system 300 from the surface 6300 of the drift 6100 or chamber 6200 up one of ramps 235, 245 of the top platform 200 and onto the work platform 520 of the equipment deck 500. The equipment deck 500 is then lowered down the raise 5100 by the synchronized winches 461, 462, 463, 464 under the control of the control system 300 to a lowered position 502 at the bottom 5102 of the raise 5100 above or at the stope 5000. While in the lowered position 502, the mobile drill 8000 is controlled by the control system 300 to perform drilling operations, the progress of which may be viewed by CCTV cameras by an operator 7000 positioned locally at the top platform 200 or remotely from the drift 6100, chamber 6200, or even the underground mine 6000 (e.g., from the surface 6400 of the mine 6000). When drilling operations are completed, the equipment deck 500 is raised up the raise 5100 by the synchronized winches 461, 462, 463, 464 under control of the control system 300 and is returned to its raised position 501 docked in the access opening 250 of the top platform 200. The mobile drill 8000 may then be moved off of the work platform 520 of the equipment deck 500, down one of the ramps 235, 245 of the top platform 200, and back onto the surface 6300 of the drift 6100 or chamber 6200. Similar operations may then be followed for second equipment, for example, a mobile emulsion loader (or mobile blast equipment) 8000. While in the lowered position 502, the mobile emulsion loader 8000 is controlled by the control system 300 to perform explosives loading operations, that is, to load the holes bored by the drilling operations in the side wall 5130 of raise 5100 or stope 5000 with explosives (or emulsion) in preparation for blasting operations. When explosives loading operations are completed, the mobile emulsion loader 8000 is returned to the drift 6100 or chamber 6200 using the modular platform system 100 as described above and blasting operations may be remotely initiated using the control system 300. This process may then be repeated for the next ring of the stope 5000. When ore in the stope 5000 is depleted, the modular platform system 100 may be disassembled and moved along the drift 6100 to the location of the next raise 5100 and stope 5000 where the modular platform system 100 may be reassembled and the entire process may be repeated.

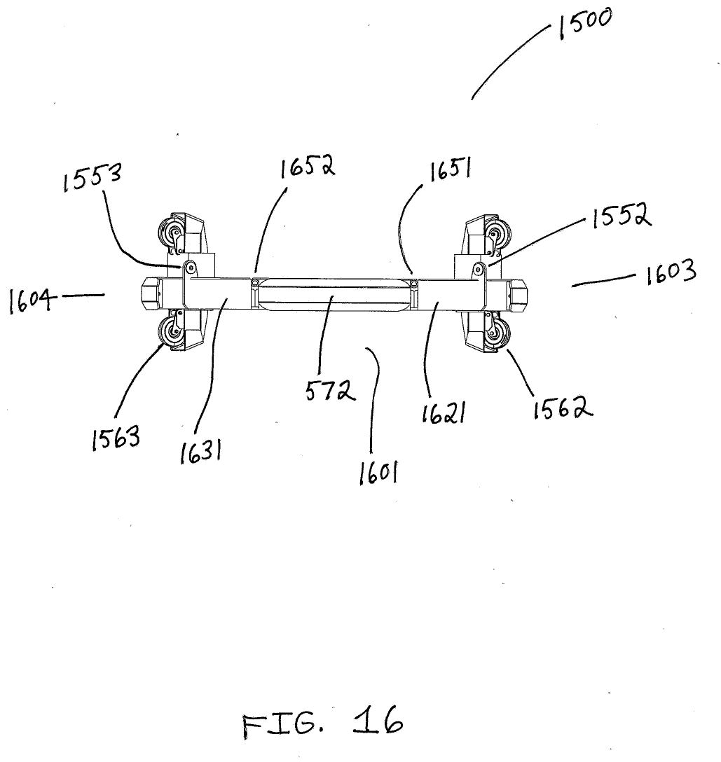

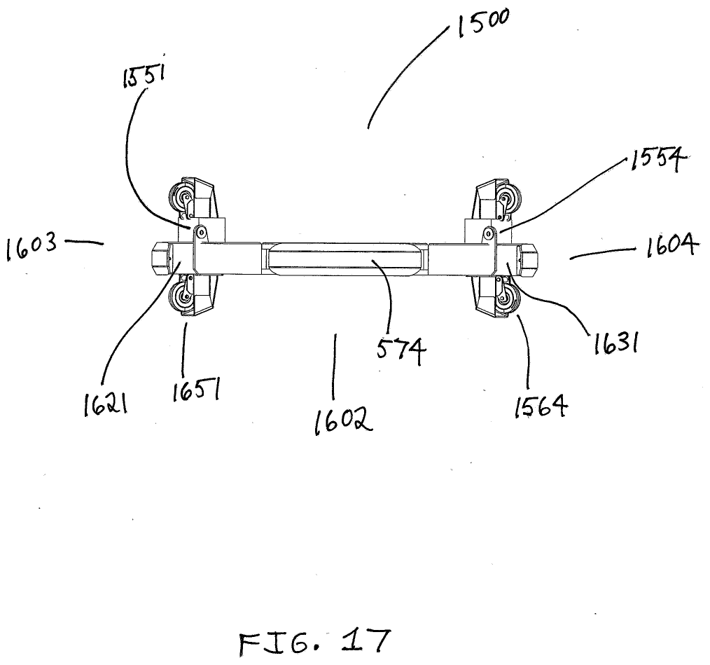

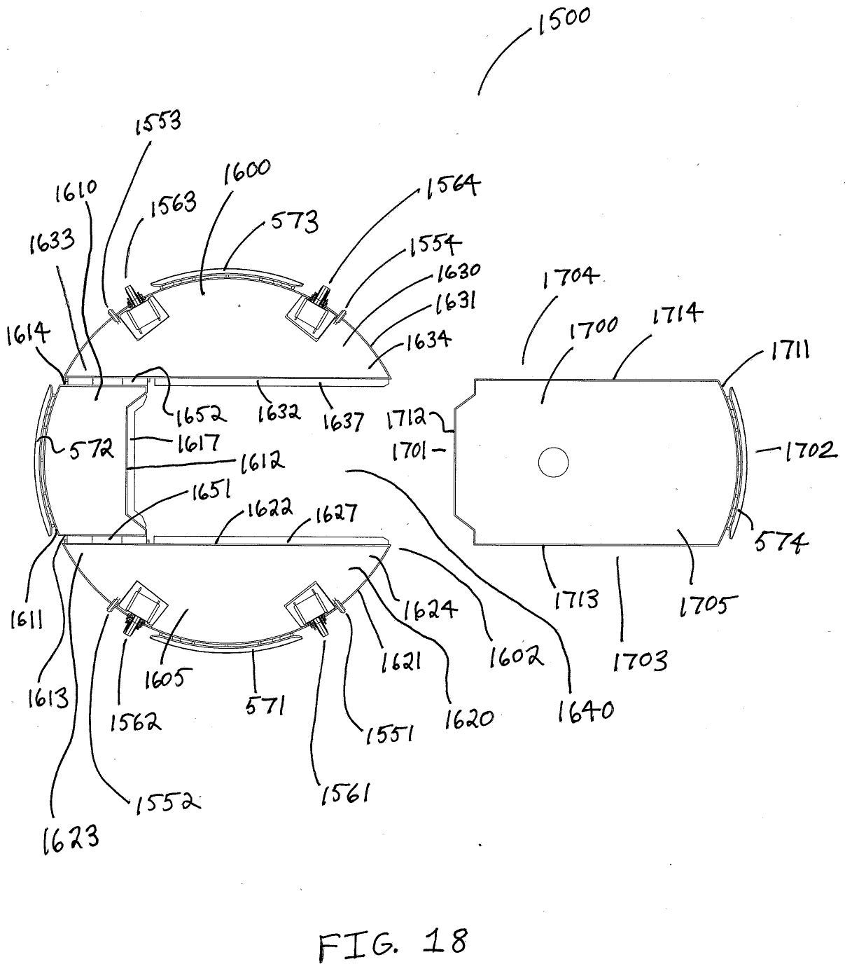

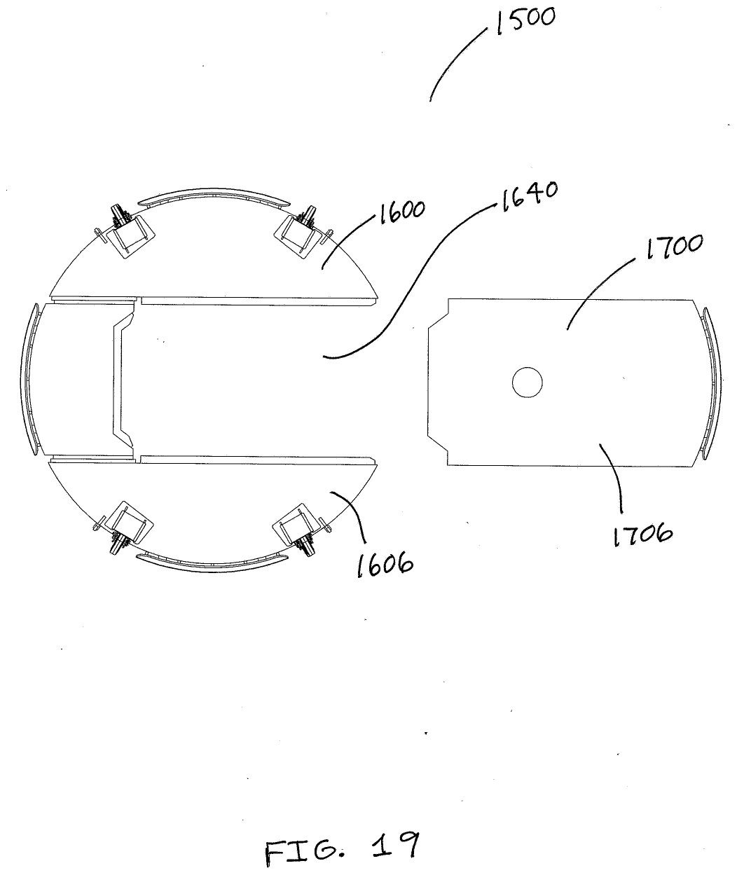

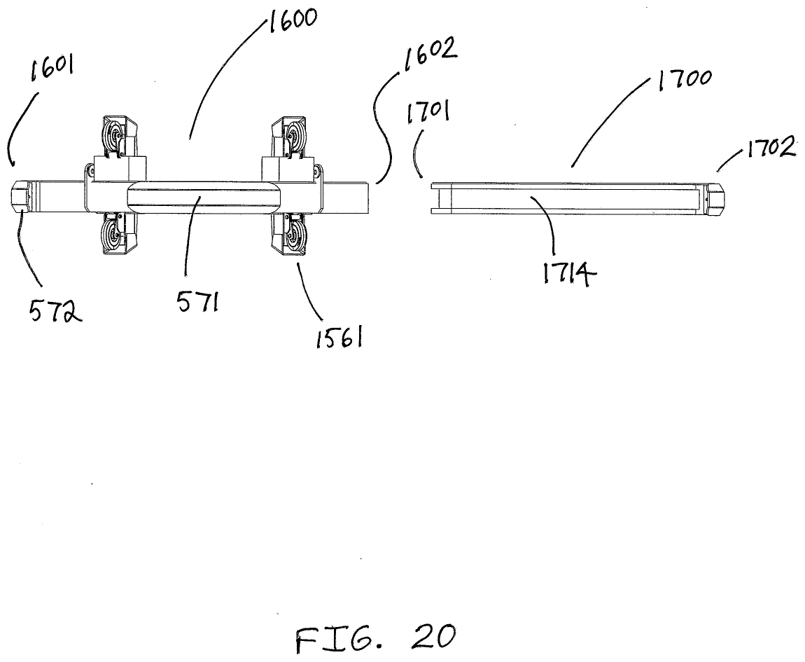

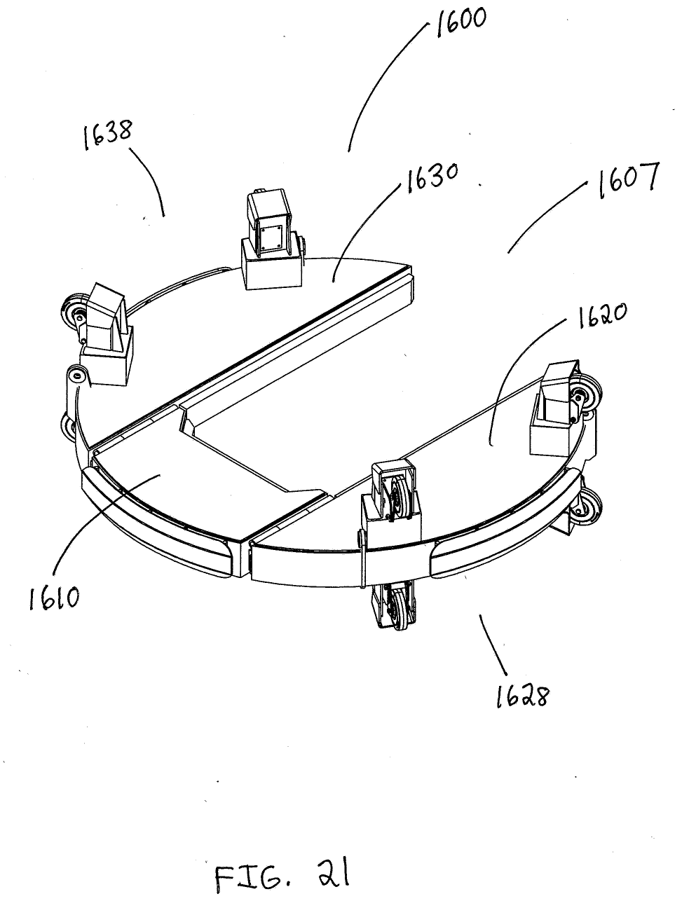

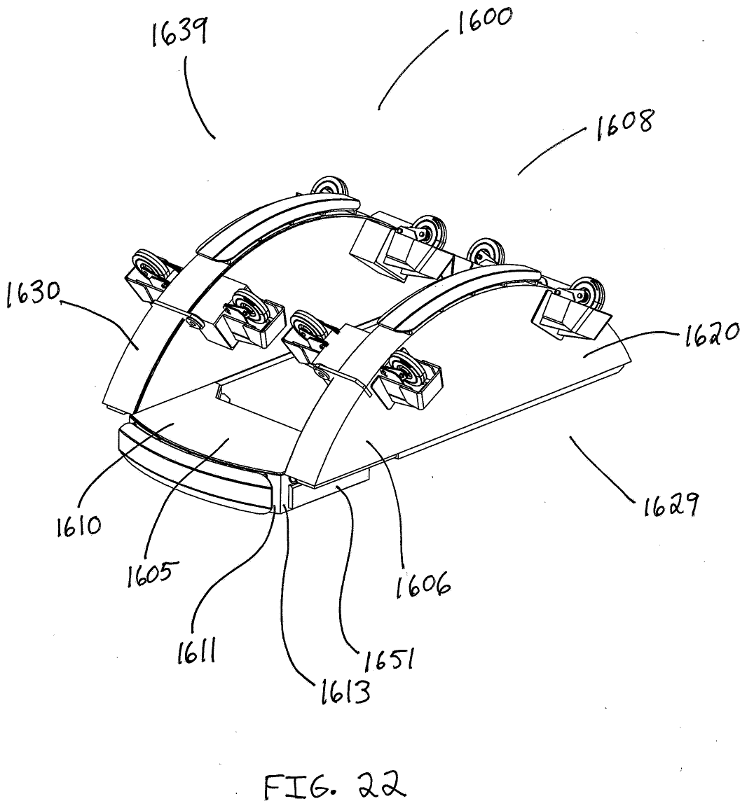

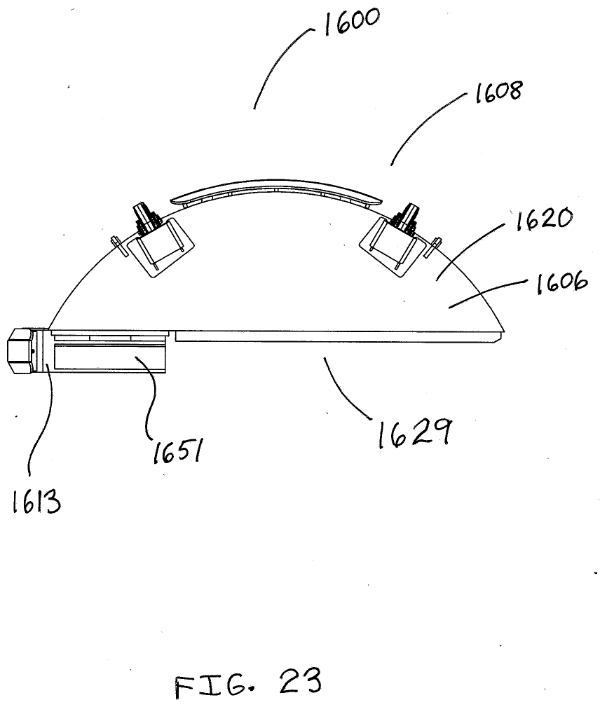

FIG. 12 is a front perspective view illustrating an equipment deck 1500 for the modular platform system 100 of FIG. 1 having a removable cassette deck 1700 and with the removable cassette deck 1700 thereof shown in an inserted position 1707 in accordance with an embodiment of the application. FIG. 13 is a bottom perspective view thereof. FIG. 14 is a front perspective view illustrating the equipment deck 1500 of FIG. 12 with the removable cassette deck 1700 thereof shown in a removed position 1708 in accordance with an embodiment of the application. FIG. 15 is a bottom perspective view thereof. FIG. 16 is a front view thereof. FIG. 17 is a rear view thereof. FIG. 18 is a top view thereof. FIG. 19 is a bottom view thereof. FIG. 20 is a right side view thereof, the left side view being substantially a mirror image thereof. FIG. 21 is a front perspective view illustrating the top deck 1600 of the equipment deck 1500 of FIG. 12 with the removable cassette deck 1700 thereof removed 1708 and with the top deck 1600 shown in an unfolded position 1607 in accordance with an embodiment of the application. FIG. 22 is a front perspective view illustrating the top deck 1600 of the equipment deck 1500 of FIG. 21 with the removable cassette deck 1700 thereof removed 1708 and with the top deck 1600 shown in a folded position 1608 in accordance with an embodiment of the application. And, FIG. 23 is a right side view thereof, the left side view being substantially a mirror image thereof.

According to another embodiment of the application, the

equipment deck 1500 includes a top deck 1600 and a removeable cassette deck or cassette 1700. Mobile and/or stationary equipment 8000 may be mounted on the cassette 1700 which may then be inserted into the top deck 1600 and the equipment deck 1500 may then be operated in a manner similar to the equipment deck 500 of FIG. 7 with any necessary height adjustments made to the synchronized winches 261, 262, 263, 264 of FIG. 3. The equipment deck 1500 may include additional equipment decks 1500, top decks 1600, or cassettes 1700 spacedly mounted below or above the equipment deck 1500, top deck 1600, or cassette 1700, respectively, depending on the nature of the equipment 8000 to be accommodated.

According to one embodiment, the equipment deck 1500 includes: a top deck 1600 having an upper surface 1605, a lower surface 1606, and at least one side wall (or side) 1611 1621, 1631 having an outer surface 1615, 1625, 1635, the top deck 1600 having a slot (or open-sided slot, channel, recess, opening, indent, notch, etc.) 1640 formed therein for receiving a removable cassette deck or cassette 1700, the top deck 1600 having at least one side wall (or side) (or portion thereof) 1612, 1622, 1632 proximate to and defining the slot 1640; first, second, third, and fourth lift/anchor points 1551, 1552, 1553, 1554 (similar to 551, 552, 553, 554) spacedly mounted to the outer surfaces 1615, 1625, 1635 of the side walls 1611, 1621, 1631 of the top deck 1600; and, first, second, third, and fourth guide wheels (or guide wheel pairs) 1561, 1562, 1563, 1564 (similar to 561, 562, 563, 564) mounted to the upper and/or lower surfaces 1605, 1606 of the top deck 1600 proximate to the first, second, third, and fourth lift/anchor points 1551, 1552, 1553, 1554, respectively. The guide wheels 1561, 1562, 1563, 1564 may be rubber guide wheels (or have rubber tires).

According to one embodiment, the top deck 1600 has a front end 1601, a rear end 1602, a right side 1603, a left side 1604, an upper or top surface 1605, and a lower or bottom surface 1606. The top platform 1600 includes a front or middle deck 1610, a right or first side deck 1620, and a left or second side deck 1630. The front deck 1610 has an outer side wall (or side) 1611, an inner side wall (or side) 1612, a first or right side wall (or side) 1613, and a second or left side wall (or side) 1614. The right side deck 1620 has an outer side wall (or side) 1621 and an inner side wall (or side) 1622. Similarly, the left side deck 1630 has an outer side wall (or side) 1631 and an inner side wall (or side) 1632. Note that when installed in the modular platform system 100, the right side deck 1620 is typically positioned adjacent to the front deck 210.

The right side 1613 of the front deck 1610 may be removably attached (e.g., coupled, bolted, fastened, pinned, etc.) to the inner side 1622 of the right side deck 1620 proximate a front end 1623 thereof and the left side 1614 of the front deck 1610 is removably attached to the inner side 1632 of the left side deck 1630 proximate a front end 1633 thereof. The inner sides 1622, 1632 of the side decks 1620, 1630 are longer than the left and right sides 1613, 1614 of the front deck 1610 and, as such, when the front, right side, and left side decks 1610, 1620, 1630 are attached, the slot 1640 is formed in the top deck 1600 (i.e., defined by the respective inner sides 1612, 1622, 1632 of the front, right side, and left side decks 1610, 1620, 1630). According to one embodiment, the slot 1640 may be elongate and generally rectangular in shape.

According to one embodiment, the right and left side decks 1620, 1630 may be rotatably attached to the front deck 1610 by respective hinges 1651, 1652 (or the like) allowing the top deck 1600 to be folded as shown in FIGS. 21 to 23. In particular, the right and left side decks 1620, 1630 are movable between respective lowered positions 1628, 1638 and respective raised positions 1629, 1639 hence allowing the top deck 1600 to move between respective unfolded and folded positions 1607, 1608. Advantageously, in the folded position 1608, the top deck 1600 and the equipment deck 1500 may be more easily transported.

According to another embodiment, the front, right side, and left side decks 1610, 1620, 1630 may be rigidly attached. According to a further embodiment, the top deck 1600 may be formed in one piece and/or as one unit.

According to one embodiment, the cassette deck or cassette 1700 has a front end 1701, a rear end 1702, a right side 1703, a left side 1704, an upper or top surface 1705, and a lower or bottom surface 1706. The cassette 1700 has an outer side wall (or side) 1711, an inner side wall (or side) 1712, a first or right side wall (or side) 1713, and a second or left side wall (or side) 1714. According to one embodiment, the cassette 1700 is elongate and generally rectangular in shape and is sized and shaped to engage and mate with the slot 1640 formed in the top deck 1600. The front end 1701 of the cassette 1700 may be inserted 1707 into the slot 1640 at the rear end 1602 of the top deck 1640 as shown in FIGS. 12 to 13 or removed 1708 from the slot 1640 of the top deck 1640 as shown in FIGS. 14 to 15.

According to one embodiment, the inner side walls 1612, 1622, 1632 of the front, right side, and left side decks 1610, 1620, 1630 of the top deck 1600 proximate the slot 1640 (i.e., proximate the rear ends 1624, 1634 of the right and left side decks 1620, 1630) have a respective tongue (or raised portion) 1617, 1627, 1637 formed thereon for engaging and mating with a respective groove (or lowered portion or channel) 1717, 1727, 1737 formed on the inner, right side, and left side walls 1712, 1713, 1714 of the cassette 1700 to secure the cassette 1700 within the slot 1640 of the top deck 1600 when the cassette 1700 is moved between the removed position 1708 and the inserted position 1707.

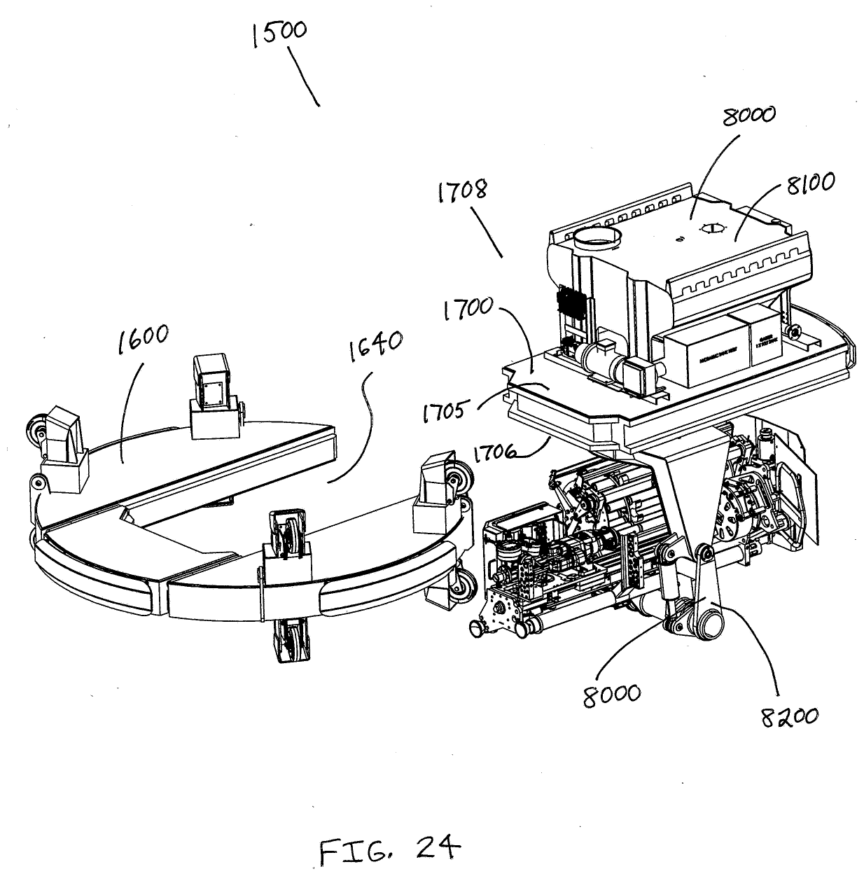

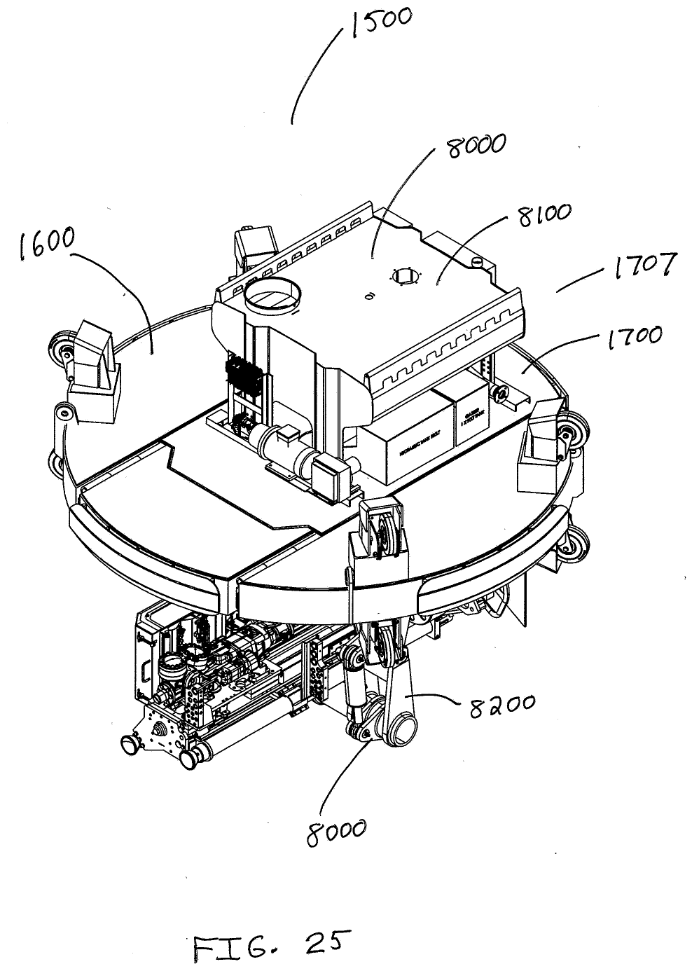

FIG. 24 is a front perspective view illustrating the equipment deck 1500 of FIG. 14 with the removable cassette deck 1700 thereof shown in a removed position 1708 and with equipment 8000 mounted on the removable cassette deck 1700 in accordance with an embodiment of the application. And, FIG. 25 is a front perspective view illustrating the equipment deck 1500 of FIG. 12 with the removable cassette deck 1700 thereof shown in an inserted position 1707 and with equipment 8000 mounted on the removable cassette 1700 in accordance with an embodiment of the application.

According to one embodiment, the mobile and/or stationary equipment 8000 may include a first component 8100 and a second component 8200. For example, the equipment 8000 may be a drilling system 8000 having a power supply component 8100 (e.g., battery, engine, fuel tank, local control system, communication system, etc.) and a drill component 8200. The power supply component 8100 may be mounted on the top surface 1705 of the cassette deck 1700 while the drill component 8200 may be mounted on the bottom surface 1706 of the cassette deck 1700 (or vise versa). Mobile and/or stationary equipment 8000 comprising a single component (e.g., 8100 or 8200) may be mounted on either the top or bottom surfaces 1705, 1706 of the cassette deck 1700 as required.

In operation, first equipment (e.g., 8000) is mounted or pre-mounted on a first cassette deck (e.g., 1700) and second equipment (e.g., 8000) is mounted or pre-mounted on a second cassette deck (e.g., 1700). Similar to the operations described above, the equipment deck 1500 is docked or positioned in (or above as required) the raised position 501 in the access opening 250 of the top platform 200 at the top 5101 of the raise 5100. The first cassette deck 1700 having first equipment, for example, a stationary drill (or stationary drilling equipment) 8000 mounted thereon is inserted 1707 into the slot 1640 of the top deck 1600 of the equipment deck 1500. The equipment deck 1500 is then lowered down the raise 5100 by the synchronized winches 461, 462, 463, 464 under the control of the control system 300 to a lowered position 502 at the bottom 5102 of the raise 5100 above or at the stope 5000. While in the lowered position 502, the stationary drill 8000 is controlled by the control system 300 to perform drilling operations, the progress of which may be viewed by CCTV cameras by an operator 7000 positioned locally at the top platform 200 or remotely from the drift 6100, chamber 6200, or even the underground mine 6000 (e.g., from the surface 6400 of the mine 6000). When drilling operations are completed, the equipment deck 1500 is raised up the raise 5100 by the synchronized winches 461, 462, 463, 464 under control of the control system 300 and is returned to its raised position 501 (or thereabove as required) docked in the access opening 250 of the top platform 200. The first cassette deck 1700 may then be removed 1708 from the slot 1640 of the top deck 1600 of the equipment deck 1500. Similar operations may then be followed for second equipment 8000, for example, a stationary emulsion loader (or stationary blast equipment) 8000. In particular, the second cassette deck 1700 having second equipment, for example, a stationary emulsion loader (or stationary blast equipment) 8000 mounted thereon is inserted 1707 into the slot 1640 of the top deck 1600 of the equipment deck 1500. While in the lowered position 502, the stationary emulsion loader 8000 is controlled by the control system 300 to perform explosives loading operations, that is, to load the holes bored by the drilling operations in the side wall 5130 of raise 5100 or stope 5000 with explosives (or emulsion) in preparation for blasting operations. When explosives loading operations are completed, the second cassette deck 1700 with the stationary emulsion loader 8000 is returned to the drift 6100 or chamber 6200 using the modular platform system 100 as described above and blasting operations may be remotely initiated using the control system 300. This process may then be repeated for the next ring of the stope 5000. When ore in the stope 5000 is depleted, the modular platform system 100 may be disassembled and moved along the drift 6100 to the location of the next raise 5100 and stope 5000 where the modular platform system 100 may be reassembled and the entire process may be repeated.

According to one embodiment, the equipment deck 1500 of FIGS. 12 to 25 may be used as a substitute for or interchangeably with the equipment deck 500 of FIGS. 1 to 11. That is, the cassette deck 1700 may be inserted into the slot 1640 of the top deck 1600 and the equipment deck 1500 may be used to transport mobile and/or stationary equipment 8000 loaded onto the upper surfaces 1605, 1705 of the top deck 1600 and cassette deck 1700. According to other embodiments, the cassette deck 1700 and mating slot 1640 formed in the top deck 1600 may have any suitable shape (e.g., rectangular, square, semi-circular, circular, etc.).

According to one embodiment, there is provided a modular platform system 100 for vertical ore stope mining, comprising: a top platform 200 having an access opening 250 formed therein for accessing a raise opening 5120 of a raise 5100 above a stope 500 of a mine 6000; an equipment deck 500, 1500 adapted to receive equipment (e.g., mobile equipment and/or stationary equipment) 8000; and, at least one winch 261, 262, 263, 264 (collectively 260) having at least one respective cable 410, 420, 430, 440 coupled thereto, the at least one winch 261, 262, 263, 264 mounted on the top platform 200, the at least one cable 410, 420, 430, 440 (collectively 400) extendable through the access opening 250, the at least one cable 410, 420, 430, 440 having at least one respective cable end 411, 421, 431, 441 coupled to the equipment deck 500, 1500; wherein the at least one winch 261, 262, 263, 264 is operable to move the equipment deck 500, 1500 and the equipment (mobile and/or stationary) 8000 between raised position 501 proximate a top 5101 of the raise 5100 at the top platform 200 and a lowered position 502 proximate a bottom 5102 of the raise 5100 at a top of or within the stope 5000.

In the above modular platform system 100, the mine may be an underground mine 6000. The top platform 200 may be adapted to be moved between raises 5000 in a drift 6100 or chamber 6200 of the underground mine 6000. The top platform 200 may include a front deck 210, a rear deck 220, a first side deck 230, and a second side deck 240 and the front, rear, first side, and second side decks 210, 220, 230, 240 may be removably attached together to thereby allow the top platform 200 of the modular platform system 100 to be disassembled, relocated, and reassembled while in the drift 6100 or chamber 6200 of the underground mine 6000. The modular platform system 100 may further include a control system 300 for controlling components (e.g., 261, 262, 263, 264) of the modular platform system 100, the at least one winch 261, 262, 263, 264, and the equipment 8000. The control system 100 may support local and remote control of the components (e.g., 260, 580, etc.) of the modular platform system 100, the at least one winch 261, 262, 263, 264, and the equipment 8000. The control system 300 may have a local user interface or control panel mounted 310 on the top platform 200 for local control. The control system 300 may have a remote user interface or control panel 310 located at a remote location at a distance (e.g., at the surface 6400 of the mine 6000) from the raise 5100, drift 6100, chamber 6200, or mine 6000 for remote control. The modular platform system 100 may further include a wired or wireless network 351 communicatively coupling the control system 300 to the components (e.g., 260, 580, etc.) of the modular platform system 100, the at least one winch 261, 262, 263, 264, and the equipment 8000. The equipment 8000 may include at least one of mobile or stationary drilling equipment and mobile or stationary blasting equipment. The equipment deck 500, 1500 may include a power supply 580 for providing power to the equipment 8000. The power supply 580 may be electrically coupled to the top platform 200 via power cabling. The one or more winches 260 may be four synchronized winches 261, 262, 263, 264. The equipment deck 500 may include a top deck 510 mounted over and spaced from a bottom deck 530 by one or more elongate struts 541, 542, 543, 544, a work platform 520 mounted over the top deck 510 for receiving the equipment 8000, and one or more respective guide wheels 561, 562, 563, 564 mounted to the one or more elongate struts 541, 542, 543, 544 between the top deck 510 and the bottom deck 530 and adapted and oriented to engage a side wall 5130 of the raise 5100. The access opening 250 and equipment deck 500, 1500 may be circular or approximately circular in shape and the equipment deck 500, 1500 may be sized to dock and mate with the access opening 250 when in the raised position 501. The modular platform system 100 may further include one or more ramps 235, 245 removably attached to the top platform 200 for providing access to the equipment deck 500, 1500 by mobile equipment 8000. The modular platform system 100 may further include one or more stabilizers 571, 572, 573, 574 spacedly mounted on an outer surface (e.g., 515, 1615, 1711) of the top deck 510, 1600 of the equipment deck 500, 1500 for stabilizing the equipment deck 500, 1500 in the access opening 250 of the top platform 200 when in the raised position 501. The power supply 580 may be an optional battery. The equipment deck 1500 may include a top deck 1600 having a slot 1640 formed therein for receiving a removable cassette deck 1700, the removable cassette deck 1700 for receiving the equipment 8000, and one or more respective guide wheels 1561, 1562, 1563, 1564 mounted to the top deck 1600 and adapted and oriented to engage a side wall 5130 of the raise 5100. And, the equipment 8000 may include mobile equipment and/or stationary equipment.

The above embodiments may contribute to an improved modular platform system 100 for vertical ore stope mining and may provide one or more advantages. First, use of the modular platform system 100 improves operator 7000 safety, increases production and efficiency of mining operations, improves drill and blast accuracy, and provides a skeleton or framework on which other or future automated underground mining equipment may be based. Second, use of the modular platform system 100 decreases ventilation requirements for underground mines 6000. Third, use of the modular platform system 100 increases safety for workers, miners, and operators 7000 via decreased exposure to geotechnically unstable environments, decreased respiratory particulate matter exposure in the mine 6000, decreased exposure to blasting, and remote operation of the modular platform system 100 and mobile and/or stationary equipment 8000 from the surface 6400. Fourth, use of the modular platform system 100 provides increased efficiency and productivity due to automation of mobile and/or stationary equipment 8000. Fifth, use of the modular platform system 100 provides increased accuracy of drilling and blasting due to automation of mobile and/or stationary equipment 8000. Sixth, use of the modular platform system 100 provides for reduced size of required excavation. Seventh, use of the modular platform system 100 allows for decreased infrastructure setup. Eighth, the modular design of the modular platform system 100 eases equipment transport and allows the modular platform system 100 to be easily relocated from stope 5000 to stope 5000. Ninth, the modular platform system 100 may be quickly assembled. Tenth, the modular platform system 100 provides built-in safety features for operators 7000. And, eleventh, the modular platform system 100 may handle both mobile and stationary equipment 8000.

The embodiments of the application described above are intended to be exemplary only. Those skilled in this art will understand that various modifications of detail may be made to these embodiments, all of which come within the scope of the application.

What is claimed is:

1. A modular platform system for vertical ore stope mining, comprising:
a top platform having an access opening formed therein for accessing a raise opening of a raise above a stope of a mine;
an equipment deck adapted to receive equipment; and,
at least one winch having at least one respective cable coupled thereto, the at least one winch mounted on the top platform, the at least one cable extendable through the access opening, the at least one cable having at least one respective cable end coupled to the equipment deck;
wherein the at least one winch is operable to move the equipment deck and the equipment between a raised position proximate a top of the raise at the top platform and a lowered position proximate a bottom of the raise at a top of or within the stope.

2. The modular platform system of claim 1, wherein the mine is an underground mine.

3. The modular platform system of claim 2, wherein the top platform is adapted to be moved between raises in a drift or chamber of the underground mine.

4. The modular platform system of claim 3, wherein the top platform includes a front deck, a rear deck, a first side deck, and a second side deck and wherein the front, rear, first side, and second side decks are removably attached together to thereby allow the top platform of the modular platform system to be disassembled, relocated, and reassembled while in the drift or chamber of the underground mine.

5. The modular platform system of claim 1, further comprising a control system for controlling components of the modular platform system, the at least one winch, and the equipment.

6. The modular platform system of claim 5, wherein the control system supports local and remote control of the components of the modular platform system, the at least one winch, and the equipment.

7. The modular platform system of claim 5, wherein the control system has a local user interface or control panel mounted on the top platform for local control.

8. The modular platform system of claim 5, wherein the control system has a remote user interface or control panel located at a remote location at a distance from the raise, drift, chamber, or mine for remote control.

9. The modular platform system of claim 5, further comprising a wired or wireless network communicatively coupling the control system to the components of the modular platform system, the at least one winch, and the equipment.

10. The modular platform system of claim 1, wherein the equipment includes at least one of mobile or stationary drilling equipment and mobile or stationary blasting equipment.

11. The modular platform system of claim 1, wherein the equipment deck includes a power supply for providing power to the equipment.

12. The modular platform system of claim 11, wherein the power supply is electrically coupled to the top platform via power cabling.

13. The modular platform system of claim 1, wherein the one or more winches are four synchronized winches.

14. The modular platform system of claim 1, wherein the equipment deck includes a top deck mounted over and spaced from a bottom deck by one or more elongate struts, a work platform mounted over the top deck for receiving the equipment, and one or more respective guide wheels mounted to the one or more elongate struts between the top deck and the bottom deck and adapted and oriented to engage a side wall of the raise.

15. The modular platform system of claim 1, wherein the access opening and equipment deck are circular or approximately circular in shape and wherein the equipment deck is sized to dock and mate with the access opening when in the raised position.

16. The modular platform system of claim 1, further comprising one or more ramps removably attached to the top platform for providing access to the equipment deck by mobile equipment.

17. The modular platform system of claim 14, further comprising one or more stabilizers spacedly mounted on an outer surface of the top deck of the equipment deck for stabilizing the equipment deck in the access opening of the top platform when in the raised position.

18. The modular platform system of claim 11, wherein the power supply is an optional battery.

19. The modular platform system of claim 1, wherein the equipment deck includes a top deck having a slot formed therein for receiving a removable cassette deck, the removable cassette deck for receiving the equipment, and one or more respective guide wheels mounted to the top deck and adapted and oriented to engage a side wall of the raise.

20. The modular platform system of claim 1, wherein the equipment includes mobile equipment and stationary equipment.
